(19) United States
(12) Patent Application Publication
(10) Pub. No.: US 2026/0311510 A1
(43) Pub. Date: Oct. 8, 2026

(54) OLED DISPLAY WITH INTEGRATED AMBIENT LIGHT MEASUREMENT SYSTEM

(71) Applicant: Harman International Industries, Incorporated, Samford, CT (US)

(72) Inventors: Peter Brandt, Pfinztal (DE); Ruediger Gausmann, St. Georgen (DE); Seongmin Lee, Waldbronn (DE)

(21) Appl. No.: 18/998,249

(22) PCT Filed: Jul. 26, 2023
(86) PCT No.: PCT/US2023/028744

§ 371 Date: Jan. 24, 2025

Related U.S. Application Data
(60) Provisional application No. 63/392,645, filed on Jul. 27, 2022.

(51) Int. Cl. G09G 3/3208

(52) U.S. Cl. CPC G06V 40/1318; G09G 3/3208; G09G 2320/0626; G09G 2320/0686; G09G 2360/144; G09G 2380/10

(57) ABSTRACT

A display system for visually presenting information may include an organic light emitting diode (OLED) screen including a field of diodes to provide voltage to the screen to emit light in one direction and receive light and detect voltage in the opposite direction, at least one switch configured to provide voltage to the field of diodes of the OLED display, a timing controller coupled to the at least one switch and configured to open the switch during a measurement mode to reverse the polarity of one of the diodes of the field of diode to receive light and detect voltage in the opposite direction, a sample and hold amplifier configured to receive a voltage from the field of diodes, and a controller configured to provide a brightness adjustment based on the indicated ambient light level as determined from the received voltage at the OLED display in the opposite direction.

### CROSS-REFERENCE TO RELATED APPLICATIONS

This application claims the benefit of U.S. provisional application Ser. No. 63/392,645 filed Jul. 27, 2022, the disclosure of which is hereby incorporated in its entirety by reference herein.

### TECHNICAL FIELD

Described herein is a display with an integrated ambient light measurement system.

### BACKGROUND

Displays, such as vehicle displays, televisions, monitors, mobile device screens, etc., are used to present information to one or more users, and often receive information via haptic readings from the user. Such displays may be organic light-emitting diode (OLED or organic LED) displays.

### SUMMARY

A display system for visually presenting information may include an organic light emitting diode (OLED) screen including a field of diodes to provide voltage to the screen to emit light in one direction and receive light and detect voltage in the opposite direction, at least one switch configured to provide voltage to the field of diodes of the OLED display, a timing controller coupled to the at least one switch and configured to open the switch during a measurement mode to reverse the polarity of one of the diodes of the field of diode to receive light and detect voltage in the opposite direction, a sample and hold amplifier configured to receive a voltage from the field of diodes in the measurement mode, the received voltage indicative of an ambient light level next to the field of diodes, and a controller configured to provide a brightness adjustment based on the indicated ambient light level as determined from the received voltage at the OLED display in the opposite direction.

In another example, the display includes a plurality of areas of the display each having a field of diodes, where the field of diodes in one area is adjusted independently of another field of diodes of another area based on the indicated ambient light level at that area.

In one embodiment, the plurality of areas includes four quadrants.

In another embodiment, the brightness adjustment is based on a content to be displayed on the display.

In another example, the content is determined based at least in part on emitted colors of the diodes.

In one embodiment, the emitted colors of the diodes detect objects within the content.

In another embodiment, the brightness adjustment is based on content being displayed and the ambient light level.

In another example, the brightness adjustment is based on an emitted color of the diode.

In another embodiment, the brightness adjustment is based on an emitted color of the diode and the ambient light level.

A display system for visually presenting information may include an organic light emitting diode (OLED) screen including a field of diodes to provide voltage to the screen to emit light in one direction and receive light and detect voltage in the opposite direction, a controller configured to switch polarity of at least one of the diodes of the field of diodes to receive light and detect voltage in the opposite direction, an amplifier configured to receive the voltage from the at least one diode of the field of diodes in a measurement mode, the received voltage indicative of an ambient light level next to the field of diodes, and a controller configured to provide a brightness adjustment based on the ambient light level as determined from the received voltage at the screen in the opposite direction.

In another example, the display system includes at least one switch configured to provide voltage to the field of diodes of the screen.

In one embodiment, the display system includes a timing controller coupled to the at least one switch and configured to open the switch during the measurement mode to reverse the polarity of one of the diodes of the field of diode to receive light and detect voltage in the opposite direction.

In another embodiment, the amplifier is a sample and hold amplifier configured to receive the voltages from the field of diodes in the measurement mode, the received voltage indicative of the ambient light level next to the field of diodes.

In another example, the display includes a plurality of areas of the display each having a field of diodes, where the field of diodes in one area is adjusted independently of another field of diodes of another area based on the indicated ambient light level at that area.

In one embodiment, the plurality of areas includes four quadrants.

In another embodiment, the brightness adjustment is based on a content to be displayed on the display.

In another example, the content is determined based at least in part on emitted colors of the diodes.

In one embodiment, the emitted colors of the diodes detect objects within the content.

In another embodiment, the brightness adjustment is based on content being displayed and the ambient light level.

In another example, the brightness adjustment is based on an emitted color of the diode and the ambient light level.

### BRIEF DESCRIPTION OF THE DRAWINGS

These and/or other features, aspects and advantages of the present disclosure will be better understood after reading the following detailed description with reference to the drawings. Throughout these drawings, the same numeral references represent the same components, where:

FIG. 1 illustrates a block diagram of an example display system;

FIG. 2 illustrates an example schematic of the display system of FIG. 1;

FIG. 3 illustrates an example schematic of the display of FIG. 1; and

FIG. 4 illustrates an example display of the display system.

For illustrative purposes, the present disclosure has provided a description of the embodiments, but the described embodiments are not exhaustive or limited to the embodiments disclosed herein. Without departing from the scope and spirit of the described embodiments, those of ordinary skill in the art will appreciate that there are many modifications and changes.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Use of displays such as organic light-emitting diode (OLED or organic LED) displays are prevalent in various technologies, including in-vehicle displays. Such displays may be used to present information to the driver for various vehicle applications and systems. In some examples, such displays may replace conventional mirrors. However, in certain conditions, visibility of the display may change, for example, in various ambient and environmental lighting conditions. Use of certain camera monitor system (CMS) may depend on clear visibility of the display.

In night conditions, the brightness of the display may be regulated to a level that the driver is not dazed or distracted by the light emitting from the display. However, during the daytime, the light emitting from the display may be brighter so as to be readable in the sunlight. Further, weather conditions may create differing ambient lighting within the vehicle cabin, such as cloudy skies, rain, etc. Moreover, different displays within the vehicle may be subject to different levels of ambient lighting. A driver side of the vehicle may be exposed to more sun than the passenger side, etc.

Typically, ambient lighting levels are detected and measured by an exposed phototransistor. Such transistors are often mounted in the vehicle, to a center console, dashboard, or the like. However, these phototransistors are often visible, and typically do not correspond to specific displays, or the ambient light level adjacent those specific displays.

Disclosed herein is a system configured to use the OLED display to determine the ambient light level by switching the direction of the diodes. A photo electric effect generated by the ambient light adjacent to the display may be used to determine the ambient light level. This may be done by reversing the polarity of a diode of the display and measuring a current of the photo electric effect. Once the ambient light level is determined, the brightness level of the display may be adjusted based on the determined ambient light level.

That is, the diodes of the display may be used to switch the OLED structure in the video sync region to act as an ambient light sensor. This may require the OLED structure to work in a reverse direction by switching the supply voltages across select diodes. A control signal from the OLED to an integrated circuit (IC) may be simulated in the measurement mode. This may allow the IC to continue to operate continuously during the ambient light measurement.

A timing controller may control the timing of the switches. In the measuring mode, the OLED is switched in reverse and the photocurrent, generated by the corresponding ambient brightness, is fed through an impedance converter and a sample and hold circuit. The output signal after the sample and hold circuit is then proportional to the ambient brightness and may be used for general brightness control.

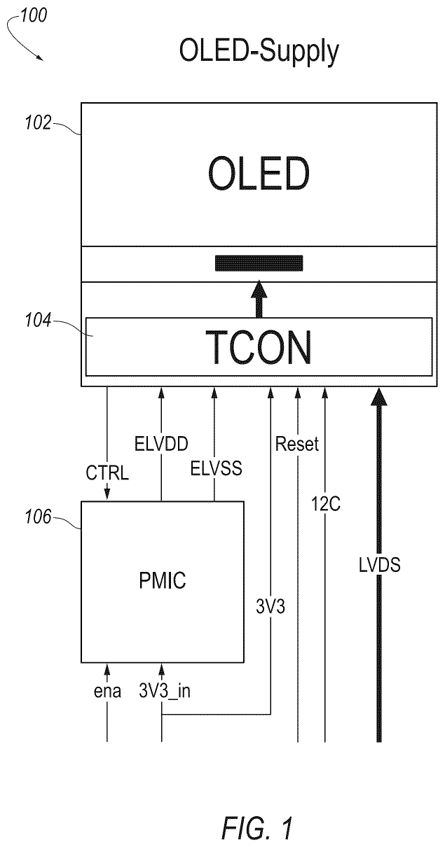

FIG. 1 illustrates an example display system 100 having a display 102 such as an OLED display. Other display types may be contemplated. The display 102 may be a screen configured to visually present information of a user. The display 102 may include a field of diodes configured to emit light to display content. The display 102 may be coupled to a timing controller (TCON) 104. The timing controller may generate timing panel signals to control the drive sequence of the display 102.

The display system 100 may include an integrated circuit (IC) 106. In the examples described herein, the IC 106 may be a power management integrated circuit (PMIC). The IC may be used to manage power on the display 102 and manage the range of voltages of the display 102. In some examples, the IC 106 may manage battery power, sleep modes, DC/DC converters, voltage scaling, etc. The IC 106 may generate a negative ELVSS power supply and positive ELVDD power supply. The ELVDD may operate at 4.3-5.2V and 300 mA, while the ELVSS may operate with −4.3-−5.5V and 300 mA. A 3V3 source may have a current of 180 mA.

The display 102 may also receive a low voltage differential signal (LVSD), defining the serial signaling standard. A I2C may provide a serial communication bus to the display 102. While a single display system 100 is illustrated in FIG. 1, more than one display system may be appreciated to work with other display systems. This may especially be the case for in-vehicle displays where multiple displays are used in place of mirrors. In one example, each seat back may include the display 102. The display system 100 may also be part of a monitor or personal computer display, laptop, tablet, home theatre, mobile device, just to name a few.

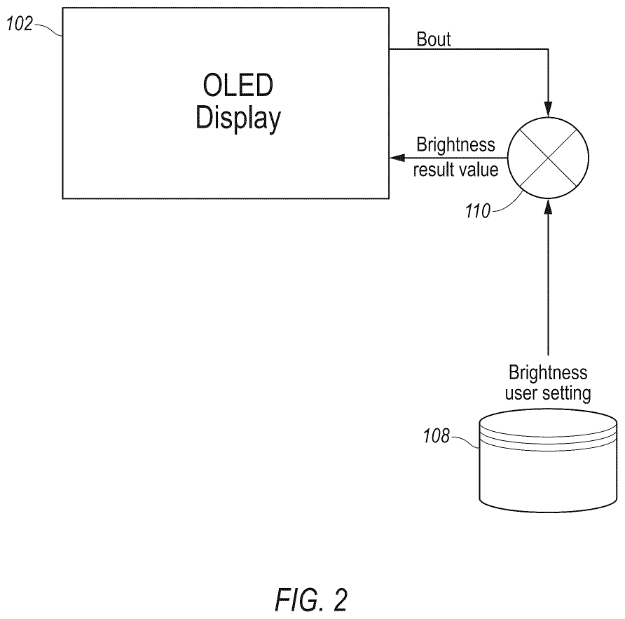

FIG. 2 illustrates an example schematic of the display system 100 of FIG. 1. The display 102 may produce an output signal Bout during the measurement mode. Bout may be a signal indicative of the ambient light level as detected by the display 102 during the measurement mode. The signal Bout may carry a current or voltage value that correlates to an ambient light level. A controller 110 may be coupled to the display 102. The controller 110 may, in some examples, be the timing controller 104 of FIG. 1. In another example, the controller 110 may be a special purpose or separate controller configured to control the brightness level of the display 102.

The controller 110 may receive Bout. The controller 110 may also receive brightness data or brightness settings. The brightness data may be an adjustment value that corresponds to the ambient light level of Bout. The brightness data may be based on a general look up table or database 108. Such database may be generated based on desired or predefined brightness levels for each ambident light level and may be received from various entities, manufactures, jurisdictions, etc. The database 108 may also maintain user settings of preferred brightness levels at various ambient light levels. Brightness levels transmitted to the controller may be manipulated in many ways and in one example may be a hybrid of user settings and predefined brightness levels.

In some examples, the user may be able to set preferences regarding the brightness level via the display 102 in the display is capable of receiving user input. The database may be updated according to a specific user identifier. Additionally or alternatively, certain levels may be customized based on the location of the specific screen. A main head unit display located in a center console may have different settings and brightness levels than that of displays arranged on the seatback and visible to passengers in the rear seat.

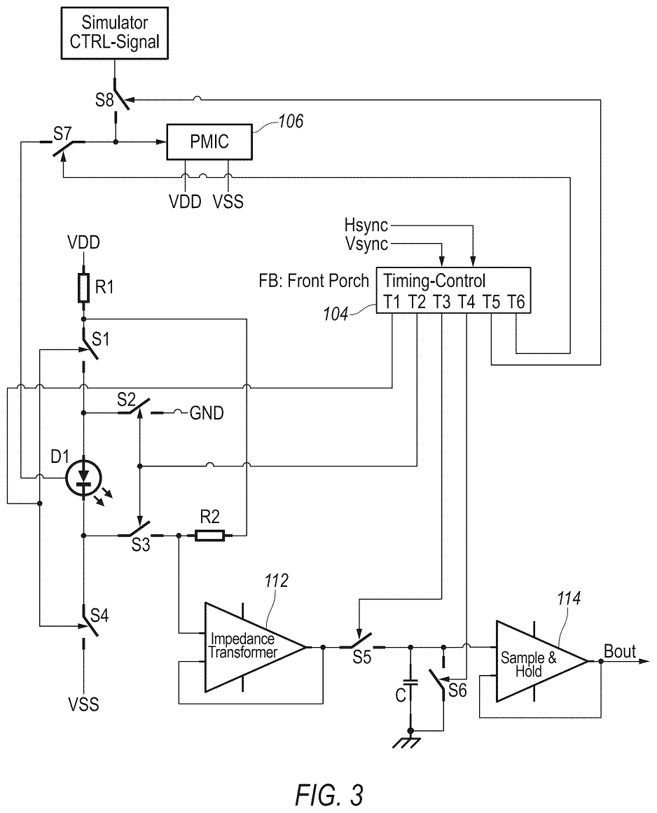

The controller 110 may correlate the received ambient light level with a brightness adjustment based on the database 108 and/or other factors. The controller 110 may then transmit a brightness result value back to the display 102. The display 102 may subsequently adjust its brightness based on the command received from the controller 110. The brightness level may be adjusted to optimize the brightness of the display with the current ambient light. In another example, the database may maintain vehicle specific settings configured to be attributed to the brightness data. Specifics regarding such adjustments are discussed in more detail with respect to FIG. 3.

FIG. 3 illustrates an example schematic of the display system 100 of FIG. 1. The display system 100 may include the IC 106 and the timing controller 104. The system 100 may include a first diode D1 and a plurality of switches S1-S8. The first diode D1 may be one diode in a field of diodes making up the OLED display. The switches may be controlled by the timing controller 104. The system 100 may also include an impedance transformer 112 and a sample and hold amplifier 114. The amplifier 114 may continuously sample the voltage of the display. This may determine the current or voltage for the Bout value. This value may indicate the ambient light level of the display 102. While one diode is illustrated, it is understood that the display system 100 includes a plurality of diodes or field of diodes.

The first diode D1 may behave as an LED under normal circumstances. However, the first diode D1 may also be capable of acting as a light sensor. This is achieved by changing the polarity of the first diode D1 during the measurement mode. To alter the functionality of the first diode D1, the timing controller 104 instructs switches S1-D4 to open. The ambient light adjacent to the display 102 during the measurement mode generate electrons creating a current within the display 102. The first diode D1 may receive these electrons at a conductive layer of the diode. The associated current is indicative of the ambient light targeting the display 102 and may indicate an ambient light level. During the measurement mode, the first diode D1 may blank for a short amount of time, but such blanking time is not perceivable to the user. In one example, the measuring mode may occur at a frequency of 60 Hz, though higher or lower frequencies may be contemplated.

The reversed photo current through the first diode D1 is received by the impedance transformer 112 and subsequently the sample and hold amplifier 114. The output signal Bout is proportional to the ambient brightness and can be used by the controller 110 of FIG. 2 for brightness control. The display system 100 may continuously switch the polarity of the first diode D1 and provide updated Bout values. The Bout value may then be used to continuously adjust the brightness level of the display as the ambient light level changes.

That is, each diode in the field of diodes may switch the direction of the voltage. In one direction, the diodes may emit light to display content on the display 102. In an opposite direction, each diode may receive light which is then used to determine the ambient light level adjacent that diode. The controller 110 may then provide a brightness adjustment based on the indicated ambient light level.

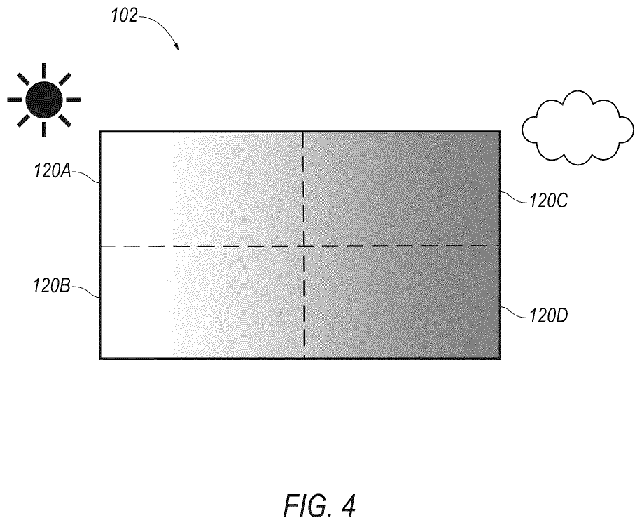

FIG. 4 illustrates an example display 102 of the display system 100 where the display 102 includes a plurality of portions or areas 120, each may be subject to a differing ambient light level. That is, in one quadrant or on one side, the display 102 may be subjected to sunlight. On the opposite side, the display 102 may be under cloudy conditions. This may especially be the case in larger displays (e.g., 24-inch displays), where light may hit the display 102 in different areas. The field of diodes within the specific area 120 may adjust its brightness according to the detected ambient light level. Such an adjustment may differ from the other areas 120, which may benefit from another adjustment specific to the ambient light level of that area 120. That is, the left side of a display 102 may have a different adjustment than the right side of the display 102. Further, each diode may be independently adjusted and while specific quadrants are illustrated as being defined in FIG. 4, any area may be adjusted according to the light received at that specific diode. That is, gradient adjustment between the various areas 120 may occur where each diode is adjusted based on the detected light level at that diode.

While the plurality of areas 120 is illustrated as including four quadrants, more or less areas may be contemplated. The arrangement of such areas may also be varied, in that the areas may not necessarily be equally distributed over the display. In some examples, a part of a display may be generally blocked from light hitting that area by a vehicle component or passenger. This area may have a size and shape according to the blockage. For example, a steering column may prevent a left side of a central display from receiving ambident light from the windows. In this example, that portion or area of the display may be predefined.

Furthermore, the brightness adjustment may be based on the content of the display. For example, the content may include a background with an object on it, such as a sky with a cloud. In one example, where the ambient light level is low (e.g., at night), the brightness adjustments may adjust the brightness of the object, such as the cloud, but leave the background, the sky, at a darker brightness. The brightness adjustment may be based on the emitted color of the diode as well.

Accordingly, a lower cost, more efficient system is described herein for using an OLED display as a photosensor to adjust the display brightness. The need for a separate photosensor that is costly and aesthetically unpleasing is eliminated. Further, in the example of multiple displays being present, each display may be updated based on the ambient light at that display, increasing user experience and visibility.

Various aspects of the current embodiments may be embodied as a system, a method, or a computer program product. Therefore, various aspects of the present disclosure may take the following forms: a complete hardware embodiment, a complete software embodiment (including firmware, resident software, microcode, etc.), or a combination of software and hardware embodiments, which may be all regarded as “module” or “system” generally herein. In addition, any hardware and/or software technology, process, function, component, engine, module, or system described in the present disclosure may be implemented as a circuit or a group of circuits. In addition, various aspects of the present disclosure may take the form of a computer program product embodied in one or more computer-readable media on which computer-readable program code is embodied.

Any combination of one or more computer-readable media may be utilized. The computer-readable mediums may be a computer-readable signal medium or a computer-readable storage medium. The computer-readable storage medium may be, for example, but not limited to, an electronic, magnetic, optical, electromagnetic, infrared, or semiconductor system, device or apparatus, or any suitable combination of the foregoing. More specific examples (non-exhaustive list) of computer-readable storage media may include each of the following: an electrical connection with one or more wires, a portable computer floppy disk, a hard disk, a random access memory (RAM), a read only memory (ROM), an erasable programmable read-only memory (EPROM or flash memory), an optical fiber, a portable CD-ROM, an optical storage apparatus, a magnetic storage apparatus, or any suitable combination of the foregoing. In the context of this document, a computer-readable storage medium may be any tangible medium that can contain or store a program for use by an instruction execution system, device, or apparatus or in combination with the instruction execution system, device, or apparatus.

The aspects of the present disclosure are described above with reference to flowchart illustrations and/or block diagrams of methods, devices (systems) and computer program products according to the implementations of the present disclosure. It will be understood that each block of the flowchart illustrations and/or block diagrams and combinations of blocks in the flowchart illustrations and/or block diagrams may be implemented by computer program instructions. These computer program instructions may be provided to processors of general purpose computers, special purpose computers, or other programmable data processing devices to produce machines. When the instructions are executed via the processors of the computers or other programmable data processing devices, the functions/actions specified in the flowchart and/or block diagram block or multiple blocks can be realized. These processors m be, but are not limited to, general purpose processors, special purpose processors, special application processors, or field programmable gate arrays.

The flowcharts and block diagrams in the drawings illustrate the architecture, functionality, and operation of possible implementations of systems, methods, and computer program products according to various embodiments of the present disclosure. In this regard, each block in the flowchart or block diagram may represent a module, section, or part of code, and the code includes one or more executable instructions for implementing prescribed logical functions. It should also be noted that in some alternative implementations, the functionality described in the blocks may occur out of the order described in the drawings. For example, two blocks shown in succession may actually be executed substantially simultaneously, or the blocks may sometimes be executed in the reverse order depending on the functionality involved. It should also be noted that each block in the block diagram and/or flowchart illustration and the combination of the blocks in the block diagram and/or flowchart illustration can be implemented by a dedicated hardware-based system or dedicated hardware and computer instructions that perform the specified functions or actions.

Although the foregoing content is directed to the embodiments of the present disclosure, other and additional embodiments of the present disclosure may be conceived without departing from the basic scope of the present disclosure, and the scope of the present disclosure is determined by the appended claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A display system for visually presenting information, comprising:
an organic light emitting diode (OLED) screen including a field of diodes to provide voltage to the screen to emit light in one direction and receive light and detect voltage in an opposite direction;
at least one switch configured to provide the voltage to the field of diodes of the OLED screen;
a timing controller coupled to the at least one switch and configured to control the at least one switch during a measurement mode to reverse a polarity of one diode of the field of diodes to receive light and to detect the voltage in the opposite direction;
a sample and hold amplifier configured to receive the voltage from the field of diodes in the measurement mode, the received voltage indicative of an ambient light level next to the field of diodes; and
a controller configured to provide a brightness adjustment based on the indicated ambient light level as determined from the received voltage at the OLED screen in the opposite direction.

2. The display system of claim 1, wherein the screen includes a plurality of areas of the screen each having a field of diodes, where the field of diodes in one area is adjusted independently of another field of diodes of another area based on the indicated ambient light level at that area.

3. The display system of claim 2, wherein the plurality of areas of the screen includes four quadrants.

4. The display system of claim 1, wherein the brightness adjustment is based on a content to be displayed on the screen.

5. The display system of claim 4, wherein the content is determined based at least in part on emitted colors of the field of diodes.

6. The display system of claim 5, wherein the emitted colors of the field of diodes correspond to objects within the content.

7. The display system of claim 1, wherein the brightness adjustment is based on content being displayed and the ambient light level.

8. The display system of claim 1, wherein the brightness adjustment is based on an emitted color of the diode.

9. The display system of claim 1, wherein the brightness adjustment is based on an emitted color of the diode and the ambient light level.

10. A display system for visually presenting information, comprising:
an organic light emitting diode (OLED) screen including a field of diodes to provide voltage to the screen to emit light in one direction and receive light and detect voltage in an opposite direction;
a controller configured to switch polarity of at least one diode of the field of diodes to receive light and detect the voltage in the opposite direction;
an amplifier configured to receive the voltage from the at least one diode of the field of diodes in a measurement mode, the received voltage indicative of an ambient light level next to the field of diodes; and
a controller configured to provide a brightness adjustment based on the ambient light level as determined from the received voltage at the screen in the opposite direction.

11. The display system of claim 10, further comprising:
at least one switch configured to provide the voltage to the field of diodes of the screen.

12. The display system of claim 11, further comprising a timing controller coupled to the at least one switch and configured to open the switch during the measurement mode to reverse the polarity of one of the diodes of the field of diode to receive light and detect voltage in the opposite direction.

13. The display system of claim 12, wherein the amplifier is a sample and hold amplifier configured to receive the voltages from the field of diodes in the measurement mode, the received voltage indicative of the ambient light level next to the field of diodes.

14. The display system of claim 10, wherein the screen includes a plurality of areas thereof, each having a field of diodes, where the field of diodes in one area is adjusted independently of another field of diodes of another area based on the indicated ambient light level at that area.

15. The display system of claim 14, wherein the plurality of areas of the screen includes four quadrants.

16. The display system of claim 10, wherein the brightness adjustment is based on a content to be displayed on the screen.

17. The display system of claim 16, wherein the content is determined based at least in part on emitted colors of the field of diodes.

18. The display system of claim 17, wherein the emitted colors of the diodes correspond to objects within the content.

19. The display system of claim 10, wherein the brightness adjustment is based on content being displayed and the ambient light level.

20. The display system of claim 10, wherein the brightness adjustment is based on an emitted color of the at least one diode of the field of diodes and the ambient light level.
